(19) United States
(12) Patent Application Publication
(10) Pub. No.: US 2008/0232790 A1
(43) Pub. Date: Sep. 25, 2008

(54) Camera monitor

(76) Inventor: David Lai, South San Francisco, CA (US)

Correspondence Address: TROXELL LAW OFFICE PLLC, 5205 LEESBURG PIKE, SUITE 1404, FALLS CHURCH, VA, 22041, US

(21) Appl. No.: 11/727,194

(22) Filed: Mar. 23, 2007

(51) Int. Cl. G03B 15/00; H04N 5/238

(52) U.S. Cl. 396/351; 348/369; 348/E05.04

(57) ABSTRACT

A camera monitor comprises a main body, a camera device, and a reflecting mirror, wherein the main body has a cover pervious to light and is provided with at least a light thereon for illumination. The camera device is disposed within the main body and covered by the cover. The reflecting mirror is disposed on the cover at the location that corresponds to the camera lens within the main body so that an image outside the main body can be reflected by the reflecting mirror to the camera lens.

### BACKGROUND OF THE INVENTION

1. Field of the Invention

The present invention relates to a camera monitor, and more particularly, to a camera monitor that can be used for illumination and image monitor simultaneously, has a reflecting mirror for providing a wider visual angle, and is structurally simple and assembled easily so that it can be applicable for illuminating, monitoring, and recording in various public places or public transportation vehicles.

2. Description of the Prior Art

It is most dreadful when people confront danger in deserted places. Some accidental situations people may encounter, such as stealing, robbing, or disputing, usually occur unpredictably in deserted places. Thus, an optical monitor system is commonly provided for visualizing and monitoring these accidental situations in time for people reacting to and handle these situations as quickly as possible.

In addition to the requirement and application of a monitor system for home security mentioned above, a monitor system is also required and applicable to various public places, such as airports, elevators, arcades, or passageways, and various public transportation vehicles. No matter how wide the range a monitor system can cover, a monitor system usually comprises a camera monitor and a display. A user can view at once image captured by the lens of the monitor and shown through the display.

In order to widen the visual angle, one way is to add and fix many monitors in various angles for effectively monitoring, while another way is to equip a monitor with a rotatable base for rotating the monitor. No matter what the way people might adopt, it is inconvenient, complicated, and costly.

### SUMMARY OF THE INVENTION

The main object of the present invention is to provide a camera monitor with a reflecting mirror for obtaining a wider visual angle, and the camera monitor is structurally simple and can be assembled easily.

In order to achieve the above objects, the camera monitor according to the present invention comprises a main body, a camera device, and a reflecting mirror. The main body has a cover pervious to light and is provided with at least a light thereon for illumination. The camera device is disposed within the main body and covered by the cover. The reflecting mirror is disposed on the cover at the location that corresponds to the camera lens within the main body so that an image outside the main body can be reflected by the reflecting mirror to the camera lens.

Other objects, advantages and novel features of this invention will become more apparent from the following detailed description when taken in conjunction with the accompanying drawings.

### BRIEF DESCRIPTION OF THE DRAWINGS

FIG. 1 is a schematic diagram illustrating an embodiment of a camera monitor according to the present invention;

FIG. 2 shows the camera monitor in FIG. 1 in using state;

FIG. 3 is a schematic diagram illustrating an embodiment of a camera monitor according to the present invention, wherein a plane mirror is used; and

FIG. 4 shows the camera monitor in FIG. 3 in using state.

### DETAILED DESCRIPTION OF THE PREFERRED EMBODIMENTS

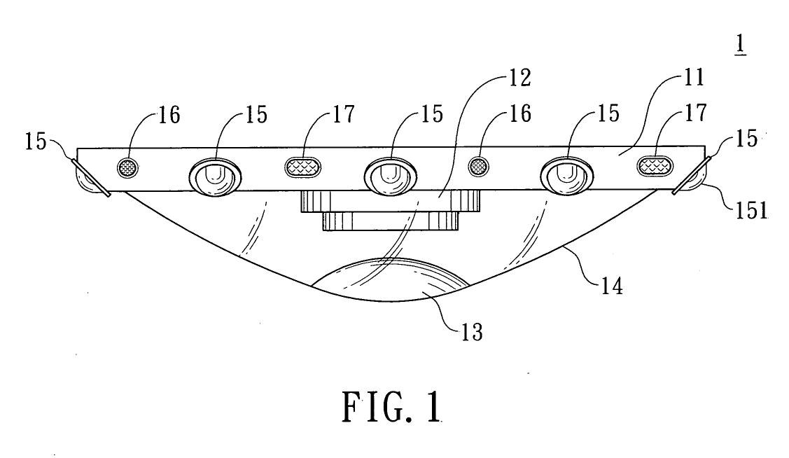

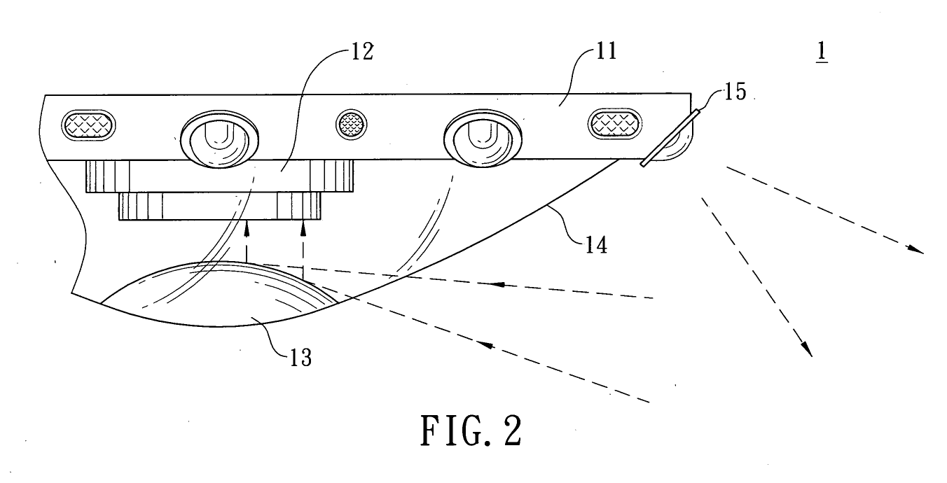

Referring to FIGS. 1 and 2, these figures show a preferred embodiment of a camera monitor 1 according to the present invention, wherein the camera monitor 1 comprises a main body 11, a camera device 12, and a reflecting mirror 13.

The main body 11 has a cover 14 pervious to light and is provided with at least a light 15 thereon for illumination. The light 15 includes a light-diverting shield 151 for preventing light from being reflected to lens of the camera 12 and focusing light. The camera device 12 is disposed within the main body 11 and covered by the cover 14. The reflecting mirror 13 is disposed on the cover at the location 14 that corresponds to the camera lens within the main body 11 so that an image outside the main body 11 can be reflected by the reflecting mirror 13 to the camera lens.

Moreover, as shown in FIG. 1, at least an audio-frequency receiver 16 and at least a speaker 17 are disposed alternately on the main body 11 so that sound information can be received via the audio-frequency receiver 16 and transmitted to the speaker 17 in public places and public transportation vehicles.

In practice, as shown in FIG. 2, the camera monitor 1 of the present invention can provide illumination via the light 15 on the main body 11 after being installed in various public places, such as airports, elevators, arcades, or passageways, and various public transportation vehicles. In the meanwhile, images around the camera monitor 1 of the present invention can be reflected via the reflecting mirror 13 on the cover 14 and then captured by the camera device 12.

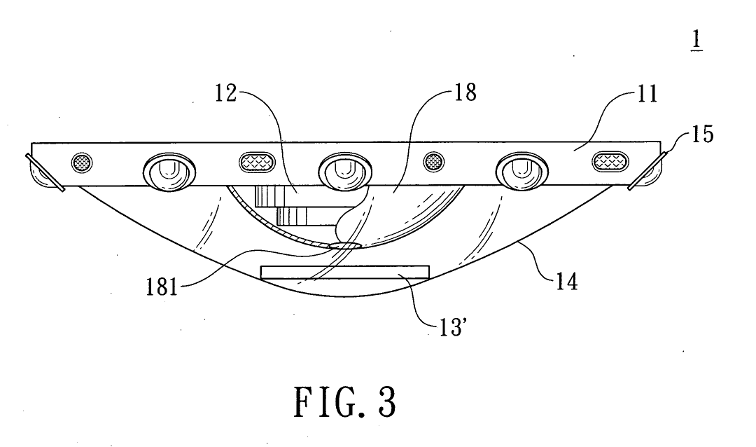

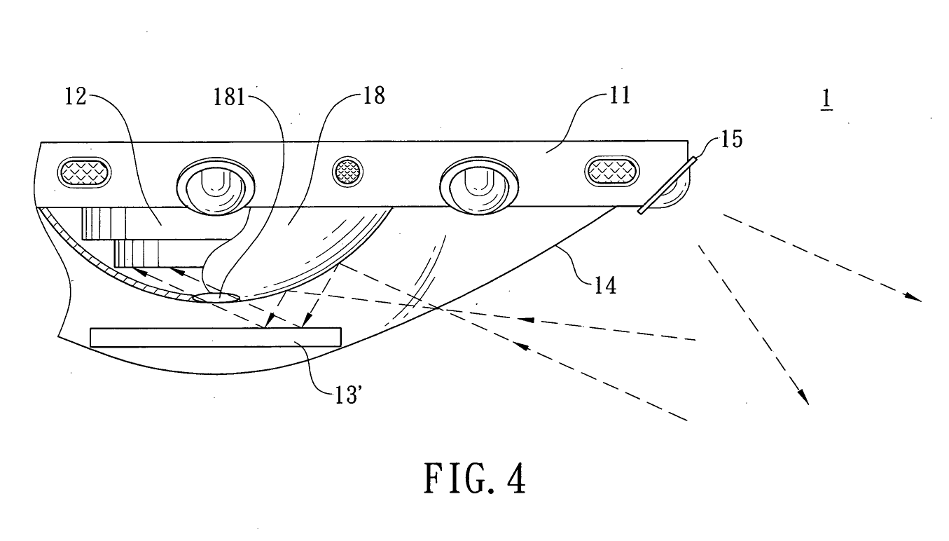

Furthermore, as shown in FIGS. 3 and 4, the reflecting mirror 13 according the present invention can be a plane mirror 13′, and the camera device 12 is covered by an mirror shield 18, on the top of which has an aperture 181 corresponding to the plane mirror 13′ for the camera device 12 taking an image, which is reflected via the mirror shield 18 to the plane mirror 13′ and then captured by the camera device 12.

Thereby, the present invention has the following advantages:

1. The camera monitor of the present invention can provide illumination and image monitor simultaneously and have wider visual angle through the reflecting mirror corresponding to the camera lens so that it is unnecessary to utilize many monitors for wider visual range.

2. The camera monitor of the present invention further comprises at least an audio-frequency receiver and at least a speaker so that sound information can be received and transmitted and thus the utility and competitiveness of a monitor system can be improved and strengthened.

Accordingly, as disclosed in the above description and attached drawings, the present invention can provide a camera monitor, which is new and can be put into industrial practice.

While the invention has been described with reference to certain embodiments, it will be understood by those skilled in the art that various changes may be made and equivalents may be substituted without departing from the scope of the present invention.

What is claimed is:

1. A camera monitor, comprising:
a main body having a cover pervious to light and at least a light for illumination;
a camera device disposed within the main body and covered by the cover; and
a reflecting mirror disposed on the cover at the location that corresponds to the lens of the camera device within the main body so that an image outside the main body can be reflected by the reflecting mirror to the camera lens.

2. The camera monitor as claimed in claim 1, further comprising at least an audio-frequency receiver and at least a speaker disposed on the main body.

3. The camera monitor as claimed in claim 2, wherein the audio-frequency receiver and the speaker are disposed alternately.

4. The camera monitor as claimed in claim 1, wherein the reflecting mirror is a plane mirror and the camera device is covered by a mirror shield, on the top of which has an aperture corresponding to the plane mirror for taking an image.

5. The camera monitor as claimed in claim 1, wherein the reflecting mirror is a curved mirror.

6. The camera monitor as claimed in claim 1, wherein the light further comprising a light-diverting shield for preventing light from being reflected to the camera lens.
